(19) United States
(12) Patent Application Publication
(10) Pub. No.: US 2024/0293918 A1
(43) Pub. Date: Sep. 5, 2024

(54) Wrench Structure

(71) Applicant: Tsan-Chang Lee, Taichung City (TW)

(72) Inventor: Tsan-Chang Lee, Taichung City (TW)

(21) Appl. No.: 18/177,173

(22) Filed: Mar. 2, 2023

(51) Int. Cl. B25B 13/46

(52) U.S. Cl. CPC B25B 13/46

(57) ABSTRACT

A wrench structure includes a first wrench body, a second wrench body, a control member, a first snap ring, and a second snap ring. The first wrench body has a driving portion, a pivot portion, and a pivot slot. The pivot portion has a first internal toothed portion, a first receiving recess, a first abutting edge, a first guide angle, a second internal toothed portion, a second receiving recess, a second abutting edge, and a second guide angle. The second wrench body has a third internal toothed portion. The control member has a first external toothed portion, a second external toothed portion, a third external toothed portion, a first snap ring groove, and a second snap ring groove. The first snap ring is received in the first snap ring groove. The second snap ring is received in the second snap ring groove.

### BACKGROUND OF THE INVENTION

### Field of the Invention

The present invention relates to a hand tool and, more particularly, to a wrench structure.

### Description of the Related Art

A conventional wrench structure was disclosed in the Taiwanese Patent No. I412437, and comprises a drive head, a handle, a control member, and a positioning unit. The drive head has a first end provided with a driving portion for driving a driven member. The drive head has a second end provided with a connecting portion. The handle is connected with the drive head by the control member. Thus, the handle drives the drive head to rotate the driven member.

However, such a conventional structure has the following disadvantages.
1. Referring to FIG. 4, the control member 30 does not have a positioning means. In operation, the control member 30 is moved freely in the first bore 111. When the control member 30 is moved, the handle 20 cannot be locked onto the drive head 10. Thus, when the user applies a force on the handle 20, the drive head 10 cannot be driven and rotated by the handle 20.
2. When the control member 30 is pressed, the handle 20 is unlocked from the drive head 10 so that the handle 20 is pivoted relative to the drive head 10 to adjust the angle between the drive head 10 and the handle 20. The control member 30 is pressed in one direction so that when the drive head 10 is turned around, the user's hand cannot press the control member 30 easily.
3. Referring to FIG. 4, the first bore 111 is provided with a first toothed portion 112, a stop portion 113, and an annular groove 114. The first toothed portion 112, the stop portion 113, and the annular groove 114 have three different diameter. The first bore 111 has a limited thickness so that it is difficult to work the first toothed portion 112, the stop portion 113, and the annular groove 114, thereby complicating the working process, and thereby decreasing the quality of product.

### BRIEF SUMMARY OF THE INVENTION

In accordance with the present invention, there is provided a wrench structure comprising a first wrench body, a second wrench body, a control member, a first snap ring, a second snap ring, a first screw member, and a second screw member. The first wrench body has a driving portion, a pivot portion, and a pivot slot. The pivot portion has a first internal toothed portion, a first receiving recess, a first abutting edge, a first guide angle, a second internal toothed portion, a second receiving recess, a second abutting edge, and a second guide angle. The second wrench body has a third internal toothed portion. The control member has a first external toothed portion, a second external toothed portion, a third external toothed portion, a first annular groove, a second annular groove, a first snap ring groove, a second snap ring groove, a first threaded portion, and a second threaded portion. The first snap ring is received in the first snap ring groove. The second snap ring is received in the second snap ring groove. The first screw member has a first abutting portion and a third threaded portion. The second screw member has a second abutting portion and a fourth threaded portion.

According to the primary advantage of the present invention, when the control member is located at the first position, the first snap ring is received in the first snap ring groove and presses the first guide angle, and the second snap ring is received in the second snap ring groove and presses the second guide angle, so that the control member is positioned at the first position by the first snap ring and the second snap ring and is not displaced in the pivot portion. Thus, the control member provides a positioning function.

According to another advantage of the present invention, when the control member is located at the first position, the first external toothed portion meshes with the first internal toothed portion and the third internal toothed portion, the second external toothed portion meshes with the second internal toothed portion and the third internal toothed portion, so that each of the first external toothed portion and the second external toothed portion meshes with two internal toothed portions.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a wrench structure in accordance with the preferred embodiment of the present invention.

FIG. 2 is a perspective view of a first wrench body of the wrench structure in accordance with the preferred embodiment of the present invention.

FIG. 3 is a front view of a control member of the wrench structure in accordance with the preferred embodiment of the present invention.

FIG. 4 is a perspective assembly view of the wrench structure as shown in FIG. 1.

FIG. 5 is a top view of the wrench structure as shown in FIG. 4.

FIG. 6 is a cross-sectional view of the wrench structure taken along line A-A as shown in FIG. 5.

FIG. 7 is a locally enlarged view of the wrench structure taken along circle B as shown in FIG. 6.

FIG. 8 is a first operational view of the wrench structure as shown in FIG. 7.

FIG. 9 is a second operational view of the wrench structure as shown in FIG. 7.

FIG. 10 is an operational view of the wrench structure as shown in FIG. 4.

### DETAILED DESCRIPTION OF THE INVENTION

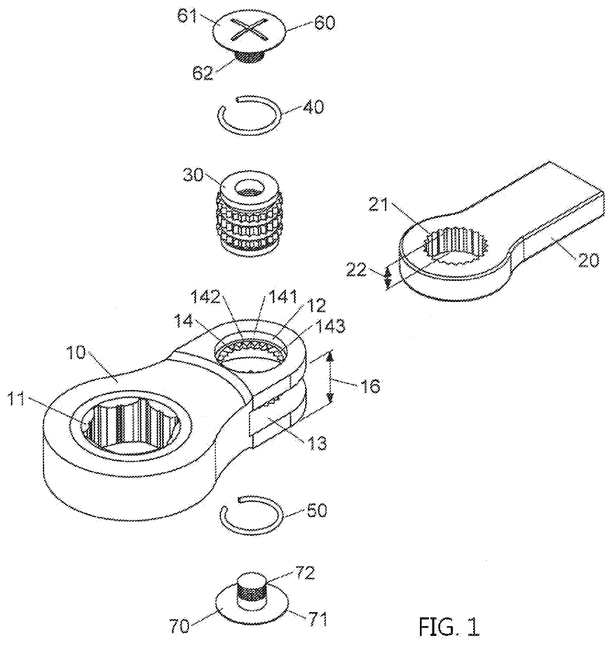

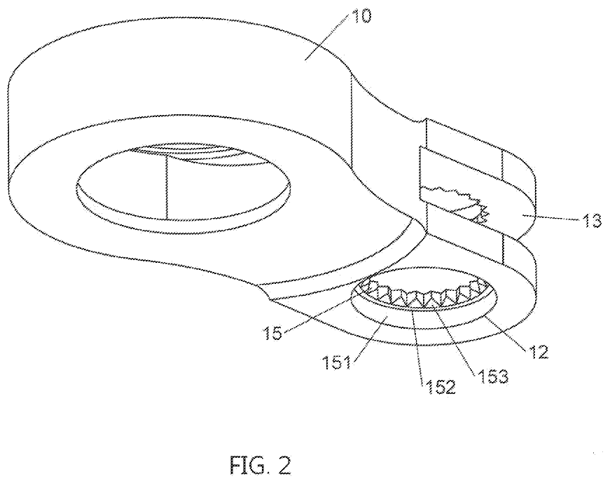

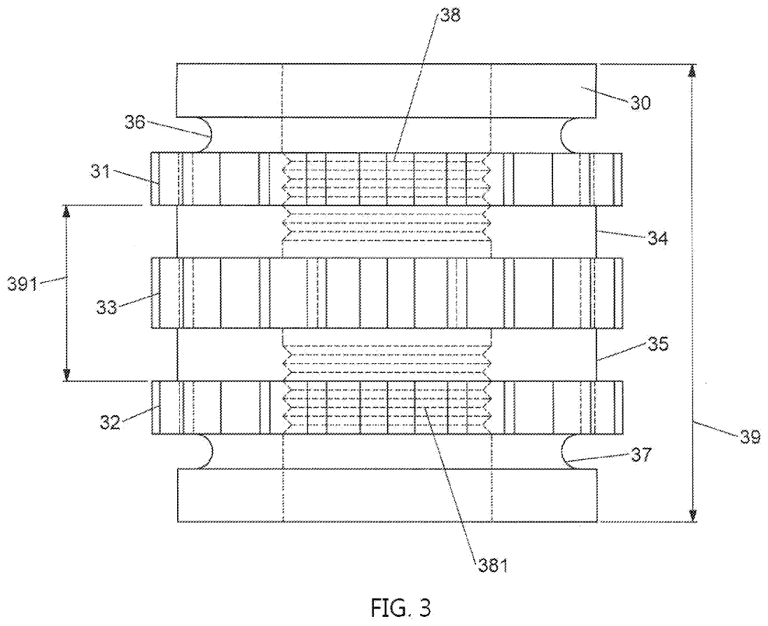

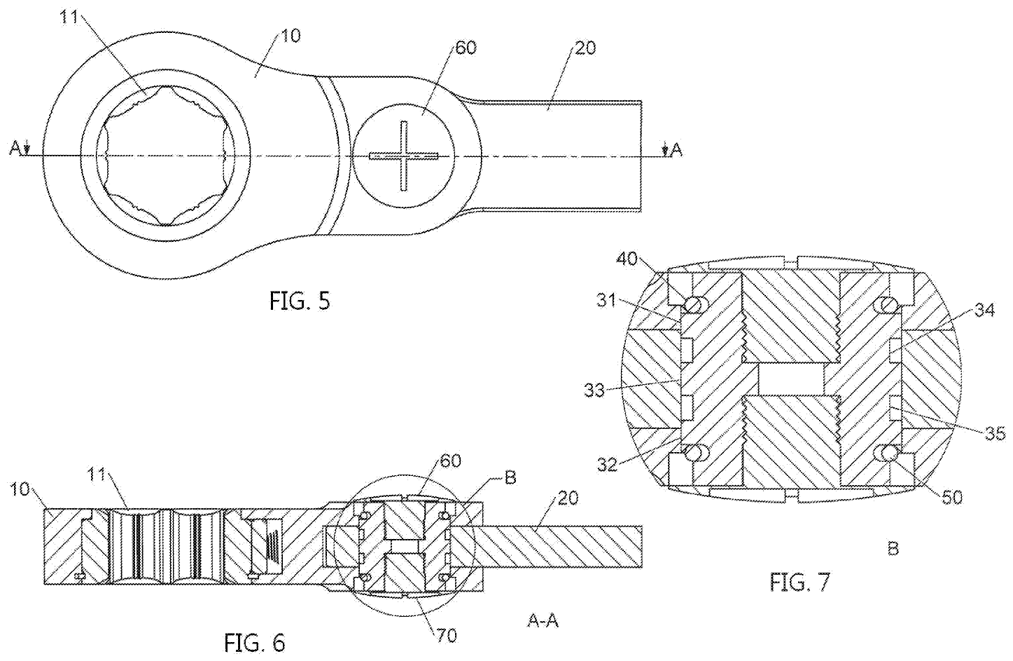

Referring to the drawings and initially to FIGS. 1-7, a wrench structure in accordance with the preferred embodiment of the present invention comprises a first wrench body 10, a second wrench body 20, a control member 30, a first snap ring 40, a second snap ring 50, a first screw member 60, and a second screw member 70.

The first wrench body 10 has a first end provided with a driving portion 11 and a second end provided with a pivot portion 12. The pivot portion 12 is a perforation or bore. The first wrench body 10 is provided with a pivot slot 13. The pivot slot 13 is a transverse opening. The pivot slot 13 is connected to the pivot portion 12. The pivot portion 12 is divided by the pivot slot 13 into an upper section and a lower section.

The pivot portion 12 has a first side provided with a first internal toothed portion 14. The first internal toothed portion 14 has an interior provided with multiple teeth arranged in an annular shape. The first internal toothed portion 14 has a side provided with a first receiving recess 141. The first receiving recess 141 has a diameter more than that of the first internal toothed portion 14. A first abutting edge 142 is formed between the first internal toothed portion 14 and the first receiving recess 141. A first guide angle (or lead angle) 143 is formed between the first internal toothed portion 14 and the first abutting edge 142.

The pivot portion 12 has a second side provided with a second internal toothed portion 15. The second internal toothed portion 15 has an interior provided with multiple teeth arranged in an annular shape. The second internal toothed portion 15 has a side provided with a second receiving recess 151. The second receiving recess 151 has a diameter more than that of the second internal toothed portion 15. A second abutting edge 152 is formed between the second internal toothed portion 15 and the second receiving recess 151. A second guide angle (or lead angle) 153 is formed between the second internal toothed portion 15 and the second abutting edge 152.

The first internal toothed portion 14 and the second internal toothed portion 15 are located between the first receiving recess 141 and the second receiving recess 151. The first internal toothed portion 14 and the second internal toothed portion 15 are arranged symmetrically relative to the first wrench body 10. The first receiving recess 141 and the second receiving recess 151 are arranged symmetrically relative to the first wrench body 10. The first abutting edge 142 and the second abutting edge 152 are arranged symmetrically relative to the first wrench body 10. The first guide angle 143 and the second guide angle 153 are arranged symmetrically relative to the first wrench body 10. The pivot portion 12 has a first size 16.

The second wrench body 20 is pivotally mounted in the pivot slot 13. The second wrench body 20 has one end provided with a third internal toothed portion 21. The third internal toothed portion 21 has an interior provided with multiple teeth arranged in an annular shape. The third internal toothed portion 21 aligns with the first internal toothed portion 14 and the second internal toothed portion 15. The second wrench body 20 is pivoted relative to the first wrench body 10 to adjust an angle therebetween. The third internal toothed portion 21 has a second size 22. The second size 22 is less than the first size 16. The second size 22 is more than one half of the first size 16.

The control member 30 is pivotally mounted on the pivot portion 12. The control member 30 is moved relative to the pivot portion 12 in two directions. The control member 30 is provided with a first external toothed portion 31, a second external toothed portion 32, and a third external toothed portion 33. A first annular groove 34 is formed between the first external toothed portion 31 and the third external toothed portion 33. The first annular groove 34 has a diameter less than that of the first external toothed portion 31 and that of the third external toothed portion 33. A second annular groove 35 is formed between the second external toothed portion 32 and the third external toothed portion 33. The second annular groove 35 has a diameter less than that of the second external toothed portion 32 and that of the third external toothed portion 33. The control member 30 has an upper end provided with a first snap ring groove 36 and a lower end provided with a second snap ring groove 37. The control member 30 is serially formed with the first snap ring groove 36, the first external toothed portion 31, the first annular groove 34, the third external toothed portion 33, the second annular groove 35, the second external toothed portion 32, and the second snap ring groove 37.

The control member 30 has a first end provided with a first threaded portion 38 and a second end provided with a second threaded portion 381. The first threaded portion 38 and the second threaded portion 381 extend in an axis of the control member 30.

The control member 30 has a height with a third size 39. The third size 39 is equal to, slightly less than or close to the first size 16. The first annular groove 34, the third external toothed portion 33, and the second annular groove 35 define a fourth size 391. The fourth size 391 is less than the second size 22.

The first external toothed portion 31 and the second external toothed portion 32 are arranged symmetrically relative to the third external toothed portion 33 and the control member 30. The first annular groove 34, the first snap ring groove 36, and the first threaded portion 38 are arranged symmetrically relative to the second annular groove 35, the second snap ring groove 37, and the second threaded portion 381 with respective to the third external toothed portion 33 and the control member 30.

The first snap ring 40 is received in the first snap ring groove 36. The first snap ring 40 presses the first guide angle 143. The first snap ring 40 is moved between the first guide angle 143 and the first internal toothed portion 14 by movement of the control member 30. The first snap ring 40 is resilient.

The second snap ring 50 is received in the second snap ring groove 37. The second snap ring 50 presses the second guide angle 153. The second snap ring 50 is moved between the second guide angle 153 and the second internal toothed portion 15 by movement of the control member 30. The second snap ring 50 is resilient.

The first screw member 60 has a first end provided with a first abutting portion 61. The first abutting portion 61 has a diameter allowing covering the first receiving recess 141. The first screw member 60 has a second end provided with a third threaded portion 62. The third threaded portion 62 is screwed into the first threaded portion 38.

The second screw member 70 has a first end provided with a second abutting portion 71. The second abutting portion 71 has a diameter allowing covering the second receiving recess 151. The second screw member 70 has a second end provided with a fourth threaded portion 72. The fourth threaded portion 72 is screwed into the second threaded portion 381.

In the preferred embodiment of the present invention, the driving portion 11 is a polygonal recess. Preferably, the driving portion 11 has a hexagonal or dodecagonal shape. The driving portion 11 may be used to drive a screw element. The driving portion 11 is a reversible ratchet wheel mechanism or a one-way ratchet wheel mechanism. The driving portion 11 may be provided with a square stud for mounting a socket.

In the preferred embodiment of the present invention, the first guide angle 143 has an oblique shape, and the second guide angle 153 has an oblique shape. Alternatively, the first guide angle 143 has a circular shape, and the second guide angle 153 has a circular shape.

In the preferred embodiment of the present invention, the second wrench body 20 is a handgrip or handle. The first threaded portion 38 is an internal thread. The second threaded portion 381 is an internal thread. The first threaded portion 38 and the second threaded portion 381 penetrate the axis of the control member 30.

In the preferred embodiment of the present invention, the third threaded portion 62 is an external thread. The third threaded portion 62 has a diameter less than that of the first abutting portion 61. The fourth threaded portion 72 is an external thread. The fourth threaded portion 72 has a diameter less than that of the second abutting portion 71.

In practice, when the control member 30 is located at a first position, the first external toothed portion 31 meshes with the first internal toothed portion 14 and the third internal toothed portion 21, the second external toothed portion 32 meshes with the second internal toothed portion 15 and the third internal toothed portion 21, and the third external toothed portion 33 meshes with the third internal toothed portion 21 as shown in FIG. 7, so that the first wrench body 10 and the second wrench body 20 are locked by the control member 30, and a relative angle between the first wrench body 10 and the second wrench body 20 is fixed and cannot be adjusted. At this time, the first snap ring 40 is received in the first snap ring groove 36 and presses the first guide angle 143, and the second snap ring 50 is received in the second snap ring groove 37 and presses the second guide angle 153, so that the control member 30 is positioned at the first position by the first snap ring 40 and the second snap ring 50 and is not displaced in the pivot portion 12.

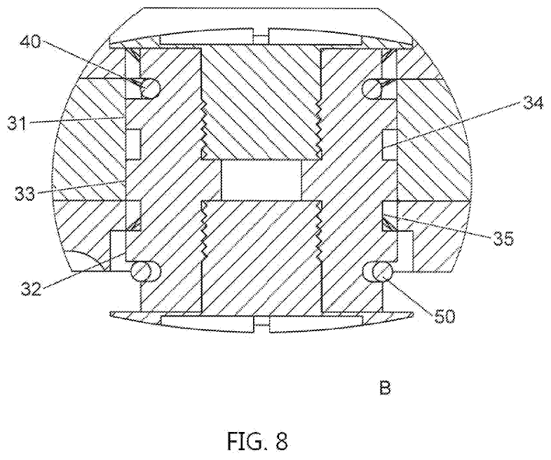

When the first screw member 60 is pressed, the control member 30 is moved to a second position as shown in FIG. 8, so that the first abutting portion 61 rests on the first abutting edge 142. At the second position of the control member 30, the first external toothed portion 31 disengages the first internal toothed portion 14 and meshes with the third internal toothed portion 21, the second external toothed portion 32 disengages the second internal toothed portion 15 and the third internal toothed portion 21, and the third external toothed portion 33 meshes with the third internal toothed portion 21 as shown in FIG. 8, so that the control member 30 meshes with the third internal toothed portion 21 only. Thus, the first wrench body 10 and the second wrench body 20 are unlocked from the control member 30, and a relative angle between the first wrench body 10 and the second wrench body 20 can be adjusted. At this time, the first snap ring 40 is moved to align with the third internal toothed portion 21, and the second snap ring 50 is exposed from the pivot portion 12.

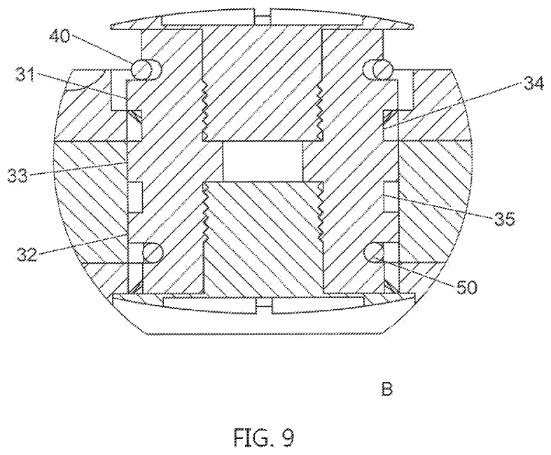

Alternatively, when the second screw member 70 is pressed, the control member 30 is moved to a third position as shown in FIG. 9, so that the second abutting portion 71 rests on the second abutting edge 152. At the third position of the control member 30, the first external toothed portion 31 disengages the first internal toothed portion 14 and the third internal toothed portion 21, the second external toothed portion 32 disengages the second internal toothed portion 15 and meshes with the third internal toothed portion 21, and the third external toothed portion 33 meshes with the third internal toothed portion 21 as shown in FIG. 9, so that the control member 30 meshes with the third internal toothed portion 21 only. Thus, the first wrench body 10 and the second wrench body 20 are unlocked from the control member 30, and a relative angle between the first wrench body 10 and the second wrench body 20 can be adjusted. At this time, the first snap ring 40 is exposed from the pivot portion 12, and the second snap ring 50 is moved to align with the third internal toothed portion 21.

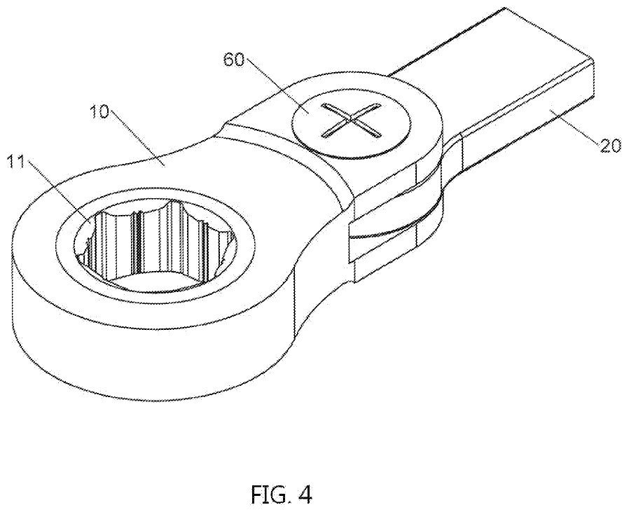

In assembly, referring to FIGS. 4-7 with reference to FIGS. 1-3, the control member 30 is received in the pivot portion 12 and located at the first position as shown in FIG. 7. The third threaded portion 62 is screwed into the first threaded portion 38. The first abutting portion 61 is received in the first receiving recess 141 and closes the opening of the first receiving recess 141. The fourth threaded portion 72 is screwed into the second threaded portion 381. The second abutting portion 71 is received in the second receiving recess 151 and closes the opening of the second receiving recess 151.

In operation, referring to FIG. 8 with reference to FIGS. 1-7, when the first screw member 60 is pressed, the control member 30 is moved to the second position as shown in FIG. 8, so that the first abutting portion 61 rests on the first abutting edge 142. At this time, the first snap ring 40 is retracted into the first snap ring groove 36 and is moved to align with the third internal toothed portion 21. In addition, the first external toothed portion 31 and the third external toothed portion 33 mesh with the third internal toothed portion 21, so that the control member 30 meshes with the third internal toothed portion 21 only. Thus, the first wrench body 10 and the second wrench body 20 are unlocked from the control member 30, and the relative angle between the first wrench body 10 and the second wrench body 20 can be adjusted freely.

Alternatively, referring to FIG. 9 with reference to FIGS. 1-7, when the second screw member 70 is pressed, the control member 30 is moved to the third position as shown in FIG. 9, so that the second abutting portion 71 rests on the second abutting edge 152. At this time, the second snap ring 50 is retracted into the second snap ring groove 37 and is moved to align with the third internal toothed portion 21. In addition, the second external toothed portion 32 and the third external toothed portion 33 mesh with the third internal toothed portion 21, so that the control member 30 meshes with the third internal toothed portion 21 only. Thus, the first wrench body 10 and the second wrench body 20 are unlocked from the control member 30, and the relative angle between the first wrench body 10 and the second wrench body 20 can be adjusted freely.

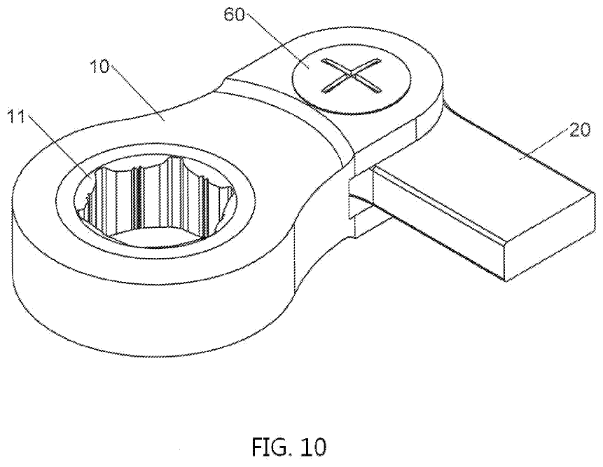

Referring to FIG. 10 with reference to FIG. 1, the second wrench body 20 is pivoted relative to the first wrench body 10, to adjust the angle between the first wrench body 10 and the second wrench body 20.

Accordingly, the wrench structure of the present invention has the following advantages.
1. When the control member 30 is located at the first position, the first snap ring 40 is received in the first snap ring groove 36 and presses the first guide angle 143, and the second snap ring 50 is received in the second snap ring groove 37 and presses the second guide angle 153, so that the control member 30 is positioned at the first position by the first snap ring 40 and the second snap ring 50 and is not displaced in the pivot portion 12. Thus, the control member 30 provides a positioning function.
2. When the control member 30 is located at the first position, the first external toothed portion 31 meshes with the first internal toothed portion 14 and the third internal toothed portion 21, the second external toothed portion 32 meshes with the second internal toothed portion 15 and the third internal toothed portion 21, so that each of the first external toothed portion 31 and the second external toothed portion 32 meshes with two internal toothed portions.
3. The first wrench body 10 and the second wrench body 20 are unlocked and pivoted relative to each other by pressing the first screw member 60 or the second screw member 70, to facilitate the user adjusting the angle between the first wrench body 10 and the second wrench body 20.
4. the first external toothed portion 31, the second external toothed portion 32, and the third external toothed portion 33 have a symmetric arrangement so that the control member 30 is designed, manufactured, and worked easily to save the cost of fabrication and to enhance the quality of product during fabrication.
5. Referring to FIG. 7, the first internal toothed portion 14, the first receiving recess 141, the first abutting edge 142, and the first guide angle 143 have different diameter, while the second internal toothed portion 15, the second receiving recess 151, the second abutting edge 152, and the second guide angle 153 have different diameter. Thus, the pivot portion 12 has two layers that are arranged symmetrically so that the pivot portion 12 is worked easily. In addition, the control member 30 is inserted into the pivot portion 12 from the first internal toothed portion 14 or the second internal toothed portion 15, so that the control member 30 is assembled with the first wrench body 10 and the second wrench body 20 in two directions.
6. Each of the pivot portion 12 and the control member 30 has a symmetric structure so that the pivot portion 12 and the control member 30 are worked easily.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A wrench structure comprising:
a first wrench body, a second wrench body, a control member, a first snap ring, a second snap ring, a first screw member, and a second screw member;
wherein:
the first wrench body has a first end provided with a driving portion and a second end provided with a pivot portion;
the pivot portion is a perforation;
the first wrench body is provided with a pivot slot;
the pivot slot is a transverse opening;
the pivot slot is connected to the pivot portion;
the pivot portion is divided by the pivot slot into an upper section and a lower section;
the pivot portion has a first side provided with a first internal toothed portion;
the first internal toothed portion has a side provided with a first receiving recess;
the first receiving recess has a diameter more than that of the first internal toothed portion;
a first abutting edge is formed between the first internal toothed portion and the first receiving recess;
a first guide angle is formed between the first internal toothed portion and the first abutting edge;
the pivot portion has a second side provided with a second internal toothed portion;
the second internal toothed portion has a side provided with a second receiving recess;
the second receiving recess has a diameter more than that of the second internal toothed portion;
a second abutting edge is formed between the second internal toothed portion and the second receiving recess;
a second guide angle is formed between the second internal toothed portion and the second abutting edge;
the first internal toothed portion and the second internal toothed portion are located between the first receiving recess and the second receiving recess;
the first internal toothed portion and the second internal toothed portion are arranged symmetrically relative to the first wrench body;
the first receiving recess and the second receiving recess are arranged symmetrically relative to the first wrench body;
the first abutting edge and the second abutting edge are arranged symmetrically relative to the first wrench body;
the first guide angle and the second guide angle are arranged symmetrically relative to the first wrench body;
the pivot portion has a first size;
the second wrench body is pivotally mounted in the pivot slot;
the second wrench body has one end provided with a third internal toothed portion;
the third internal toothed portion aligns with the first internal toothed portion and the second internal toothed portion;
the second wrench body is pivoted relative to the first wrench body to adjust an angle therebetween;
the third internal toothed portion has a second size;
the second size is less than the first size;
the second size is more than one half of the first size;
the control member is pivotally mounted on the pivot portion;
the control member is moved relative to the pivot portion in two directions;
the control member is provided with a first external toothed portion, a second external toothed portion, and a third external toothed portion;
a first annular groove is formed between the first external toothed portion and the third external toothed portion;
the first annular groove has a diameter less than that of the first external toothed portion and that of the third external toothed portion;
a second annular groove is formed between the second external toothed portion and the third external toothed portion;
the second annular groove has a diameter less than that of the second external toothed portion and that of the third external toothed portion;
the control member has an upper end provided with a first snap ring groove and a lower end provided with a second snap ring groove;
the control member is serially formed with the first snap ring groove, the first external toothed portion, the first annular groove, the third external toothed portion, the second annular groove, the second external toothed portion, and the second snap ring groove;
the control member has a first end provided with a first threaded portion and a second end provided with a second threaded portion;
the control member has a height with a third size;
the third size is equal to, slightly less than or close to the first size;
the first annular groove, the third external toothed portion, and the second annular groove define a fourth size;
the fourth size is less than the second size;
the first external toothed portion and the second external toothed portion are arranged symmetrically relative to the third external toothed portion and the control member;
the first annular groove, the first snap ring groove, and the first threaded portion are arranged symmetrically relative to the second annular groove, the second snap ring groove, and the second threaded portion with respective to the third external toothed portion and the control member;
the first snap ring is received in the first snap ring groove;
the first snap ring presses the first guide angle;
the first snap ring is moved between the first guide angle and the first internal toothed portion by movement of the control member;
the first snap ring is resilient;
the second snap ring is received in the second snap ring groove;
the second snap ring presses the second guide angle;
the second snap ring is moved between the second guide angle and the second internal toothed portion by movement of the control member;
the second snap ring is resilient;
the first screw member has a first end provided with a first abutting portion;
the first abutting portion covers the first receiving recess;
the first screw member has a second end provided with a third threaded portion;
the third threaded portion is screwed into the first threaded portion;
the second screw member has a first end provided with a second abutting portion;
the second abutting portion covers the second receiving recess;
the second screw member has a second end provided with a fourth threaded portion;
the fourth threaded portion is screwed into the second threaded portion;
when the control member is located at a first position, the first external toothed portion meshes with the first internal toothed portion and the third internal toothed portion, the second external toothed portion meshes with the second internal toothed portion and the third internal toothed portion, and the third external toothed portion meshes with the third internal toothed portion, so that the first wrench body and the second wrench body are locked by the control member;
the first snap ring is received in the first snap ring groove and presses the first guide angle, and the second snap ring is received in the second snap ring groove and presses the second guide angle, so that the control member is positioned at the first position by the first snap ring and the second snap ring.

2. The wrench structure as claimed in claim 1, wherein:
the driving portion is a polygonal recess;
the driving portion is a reversible ratchet wheel mechanism or a one-way ratchet wheel mechanism; and
the driving portion is provided with a square stud.

3. The wrench structure as claimed in claim 1, wherein:
the first guide angle has an oblique shape, and the second guide angle has an oblique shape; or
the first guide angle has a circular shape, and the second guide angle has a circular shape.

4. The wrench structure as claimed in claim 1, wherein:
the second wrench body is a handgrip;
the first threaded portion is an internal thread; and
the second threaded portion is an internal thread.

5. The wrench structure as claimed in claim 1, wherein:
the third threaded portion is an external thread;
the third threaded portion has a diameter less than that of the first abutting portion;
the fourth threaded portion is an external thread; and
the fourth threaded portion has a diameter less than that of the second abutting portion.

6. The wrench structure as claimed in claim 1, wherein:
when the first screw member is pressed, the control member is moved to a second position, so that the first abutting portion rests on the first abutting edge;
at the second position of the control member, the first external toothed portion disengages the first internal toothed portion and meshes with the third internal toothed portion, the second external toothed portion disengages the second internal toothed portion and the third internal toothed portion, and the third external toothed portion meshes with the third internal toothed portion, so that the control member meshes with the third internal toothed portion only;
the first wrench body and the second wrench body are unlocked from the control member, and a relative angle between the first wrench body and the second wrench body is adjusted;
the first snap ring is moved to align with the third internal toothed portion, and the second snap ring is exposed from the pivot portion.

7. The wrench structure as claimed in claim 6, wherein:
when the second screw member is pressed, the control member is moved to a third position, so that the second abutting portion rests on the second abutting edge;
at the third position of the control member, the first external toothed portion disengages the first internal toothed portion and the third internal toothed portion, the second external toothed portion disengages the second internal toothed portion and meshes with the third internal toothed portion, and the third external toothed portion meshes with the third internal toothed portion, so that the control member meshes with the third internal toothed portion only;
the first wrench body and the second wrench body are unlocked from the control member, and a relative angle between the first wrench body and the second wrench body is adjusted;
the first snap ring is exposed from the pivot portion, and the second snap ring is moved to align with the third internal toothed portion.
